(19) United States
(12) Patent Application Publication
(10) Pub. No.: US 2008/0164077 A1
(43) Pub. Date: Jul. 10, 2008

(54) POSITION DETECTING DEVICE AND DISPLAY DEVICE

(76) Inventor: Sadao YAMAMOTO, Koshigaya-shi (JP)

Correspondence Address: BERENATO, WHITE & STAVISH, LLC, 6550 ROCK SPRING DRIVE, SUITE 240, BETHESDA, MD, 20817, US

(21) Appl. No.: 11/945,486

(22) Filed: Nov. 27, 2007

(30) Foreign Application Priority Data
Nov. 28, 2006 (JP) P2006-320659

(51) Int. Cl. G08C 21/00; G09G 3/36

(52) U.S. Cl. 178/18.08; 345/104

(57) ABSTRACT

A position detecting device usable with a display is provided. The position detecting device includes a detector formed of a transparent member on a view-surface side of the display, and a shielding device disposed at a rear-surface side of the display configured to shield the detector from interference.

### CROSS-REFERENCES TO RELATED APPLICATIONS

The present invention claims priority from Japanese Patent Application JP 2006-320659, filed in the Japanese Patent Office on Nov. 28, 2006, the contents of which are incorporated herein by reference.

### FIELD OF THE INVENTION

The present invention relates to a position detecting device and a display device suitable for use as a display/input device to input a position directly to a view-surface. More specifically, when the position detecting device is provided on a view-surface side of a display, the invention provides stable and satisfactory position detection.

### BACKGROUND OF THE INVENTION

Among display devices having a planar view-surface, e.g., liquid crystal displays, display/input devices having a position detecting device combined with the view-surface have been provided so that an image output on the display and a position input can easily be associated with one another (see, for example, Japanese Patent No. 2139446).

Electromagnetic induction-type position detecting devices are typically used for inputting the position on these display devices. Position detectors in these devices are able to detect a position of a position indicator even when the position indicator is at a distance from the surface of the display device. Hence, there are also display/input devices that use electromagnetic induction-type position detectors which are provided on the rear-surface side of a liquid crystal display (see, for example, U.S. Pat. No. 4,988,837).

However, the electromagnetic induction-type position detector is easily affected by noise from peripheral circuitry and by magnetic fields in the environment. In an effort to shield the position detector from noise, a shielding device is provided in close proximity to the detection coils and is configured to block electromagnetic interference (see, for example, Japanese Patent No. 2608901).

As described above, various displays with position detecting devices have been provided. In the position detecting devices described above, detectors are formed of a transparent member and are provided on a view-surface side of the display, so that the configuration of the display device is not substantially modified by the detectors. Electromagnetic induction-type position detecting devices, pressure-sensing devices and other types of position detecting devices can be provided with the display device.

However, when an electromagnetic induction-type device is used as a position detecting device, a SNR (signal to noise ratio) of the detection signal in detection coils tends to be degraded due to noise from display driving circuitry and from other nearby circuitry. Particularly, when a metal plate or component, such as a metal table or metal housing, is positioned at the rear side of the display, an imbalance in signal levels due to the non-uniform existence of the metal may occur. Additionally, further degradation of the SNR may result due to interference arising from eddy currents flowing in the metal plate. In view of these considerations, it is desirable to perform stable and satisfactory position detection when a detector formed of a transparent member is provided on the view-surface side of a display.

### SUMMARY OF THE INVENTION

In light of the drawbacks of prior position detection devices, a position detecting device usable with a display having a view-surface side and a rear-surface side opposite the view-surface side is provided according to the present invention. The position detecting device includes a detector formed of a transparent member on the view-surface side of the display, and a shielding device disposed at the rear-surface side of the display configured to shield the detector from interference.

The detector may be an electromagnetic type detection coil, and the shielding device may shield the detection coil from electromagnetic interference.

The position detecting device may further include a backlight module provided at the rear-surface side of the display, and the shielding device may be attached to a rear surface of the backlight module.

The position detecting device may further include driving circuitry disposed at the rear-surface side of the display for driving the display, and the shielding device may be provided between the rear-surface side of the display and the driving circuitry.

The position detecting device may further include a metal housing covering the rear-surface side of the display, and the shielding device may be provided between the rear-surface side of the display and the metal housing.

The position detecting device may further include an auxiliary position detector in combination with the electromagnetic induction-type detection coil. The auxiliary position detector may employ a detection method other than electromagnetic induction.

A display device is also provided according to the present invention. The display device includes a display panel for displaying an image, the display panel having a view-surface side and a rear-surface side opposite the view-surface side. A detector is formed of a transparent member on the view-surface side of the display panel. A housing is formed of metal for surrounding the rear-surface side of the display panel. A shielding device is disposed between the rear-surface side of the display panel and the housing and is configured to shield the detector from interference.

The detector may be an electromagnetic induction-type detection coil, and the shielding device may be a shielding plate that shields the detection coil from electromagnetic interference.

The display device may further include a backlight module provided with the display panel, and the shielding device may be attached to a rear surface of the backlight module.

The display device may further include an auxiliary position detector in combination with the electromagnetic induction-type detection coil. The auxiliary position detector may employ a detection method other than electromagnetic induction.

A method of shielding a position detector of a display device from interference is also provided according to the present invention. The display device includes a display panel having opposing front and rear surface sides, a transparent detector disposed at the front surface side, a position indicator for electromagnetic communication with the detector, and a planar metal shielding device disposed at the rear-surface side of the display panel. The method includes the steps of receiving an electromagnetic signal from the position indicator at the detector, the electromagnetic signal having a tendency to generate eddy currents in metal surfaces located at the rear surface side of the display, and reducing the generation of eddy currents in the metal surfaces and blocking electromagnetic interference from being received at the detector using the planar metal shielding device.

According to the embodiments of the present invention, stable and satisfactory position detection can be performed without being affected by noise from display device driving circuitry and other peripheral circuitry, or by imbalance in signal levels due to the non-uniform existence of metal in a configuration in which a metal plate or component, such as a metal table or housing, is positioned at the rear surface side of the display. Further, when the display device is packaged, stable and satisfactory position detection can be made possible with the addition of the inventive shielding device to the configuration in the manner(s) set forth herein.

### BRIEF DESCRIPTION OF THE DRAWINGS

FIG. 1 is a schematic cross-sectional view showing a position detecting device and a display device according to a first embodiment of the present invention.

FIG. 2 is a schematic cross-sectional view showing a position detecting device and a display device according to a second embodiment of the present invention.

FIG. 3 is a schematic cross-sectional view showing a position detecting device and a display device according to a third embodiment of the present invention.

FIG. 4 is a schematic cross-sectional view showing a position detecting device and a display device according to a fourth embodiment of the present invention.

FIG. 5 is a schematic cross-sectional view showing a position detecting device and a display device according to a fifth embodiment of the present invention.

FIG. 6 is a schematic cross-sectional view showing a position detecting device and a display device according to a sixth embodiment of the present invention.

### DESCRIPTION OF THE PREFERRED EMBODIMENT(S)

Reference will now be made in detail to the embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification.

FIG. 1 is a schematic cross-sectional view showing a position detecting device and a display device according to a first embodiment of the present invention.

As best shown in FIG. 1, detection coils 2 of an electromagnetic induction-type position detecting device are arranged on a view-surface side of a flat-panel display 1, such as a liquid crystal display. The view-surface side is the side of the display 1 that displays images. Loop coils formed from thin wire on a transparent substrate, as disclosed in the above-described Japanese Patent No. 2139446, or coils formed from ITO (indium tin oxide) or another transparent conductive member so as not to obstruct the display 1 are used as the detection coils 2. A shielding device 3 is provided at the rear-surface side of the display 1.

When performing position detection in the display/input device configured as described above, signals of a predetermined frequency are applied to the detection coils 2. As a result, signals of the predetermined frequency are transmitted from the detection coils 2, and these signals cause resonance in a resonance circuit 11 of a position indicator 10. The resonance signals are transmitted from the position indicator 10 back to the detection coils 2. Accordingly, a position detection operation is performed. That is, the position of the detection coil 2 for which the reception level is greatest, i.e., having the greatest signal level, is detected as the position indicated by the position indicator 10.

However, when the display/input device configured as described above is, for example, placed on a metal desk 4 and the shielding device 3 is not provided, then the transmission of signals from the detection coils 2 causes eddy currents to flow in the metal of the desk 4. Due to the effect of the eddy currents, detection of the resonance signals from the resonance circuit 11 of the position indicator 10 is greatly obstructed. Hence, by providing the shielding device 3 at the rear-surface side of the display 1, the occurrence of eddy currents in the metal of the desk 4 is reduced. Moreover, interference due to eddy currents can be shielded by the shielding device 3.

A magnetic silicon steel sheet, or amorphous or conductive aluminum sheet, or the like may be used as the shielding device 3. The shielding device 3 is positioned between the detection coils 2 and the metal desk 4. Accordingly, the effect of eddy currents generated in the metal desk 4 is reduced, and signals transmitted from the position indicator 10 can be received satisfactorily in the detection coils 2.

According to the first embodiment of the invention, the detection coils 2 and the shielding device 3 are separated by a distance, so that it becomes unnecessary to use a specific type of shielding member, such as silicon steel having a predetermined silicon content, as in the above-described Japanese Patent No. 2608901. Further, according to the first embodiment of the invention, the effect not only on the metal of the rear surface side of the display, but also on electronic circuitry such as the CPU substrate of a notebook PC, is reduced, and signals transmitted from the position indicator 10 can be received satisfactorily in the detection coils 2.

According to the first embodiment of the invention, when an electromagnetic induction-type position detecting device is employed, even if a metal plate, such as a metal table, desk, or housing, is positioned at the rear-surface side of the display, signal level imbalance due to the non-uniform existence of metal and a tendency toward SNR degradation due to interference caused by eddy currents in the metal plate, can be controlled easily.

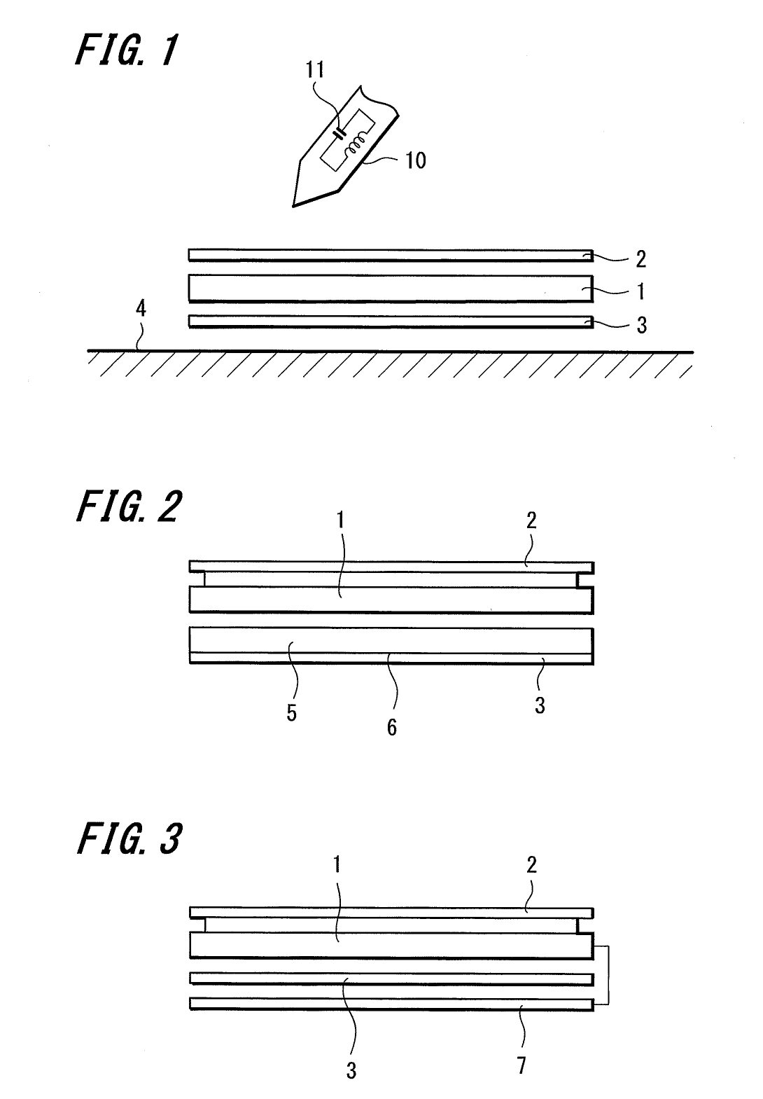

FIG. 2 is a schematic cross-sectional view showing a position detecting device and a display device according to a second embodiment of the present invention. In the second embodiment, a backlight module 5 is provided at the rear-surface side of the display 1. Other elements of the display/input device of FIG. 2 are similar to elements in the first embodiment.

In the embodiment shown in FIG. 2, the shielding device 3 is attached to the rear surface of the backlight module 5 via attachment 6 as best shown in FIG. 2). Here, if there are holes, deformations or the like in the shielding device 3, eddy currents may occur in these portions. Thus, it is preferred that the shielding device 3 be formed to have a planar shape. By attaching the shielding device 3 to the rear surface of the backlight module 5 as shown in FIG. 2, a satisfactory shielding effect is obtained.

FIG. 3 is a schematic cross-sectional view showing a position detecting device and a display device according to a third embodiment of the present invention. In the third embodiment, a circuit board 7 is provided at the rear-surface side of the display 1. Other elements of the display/input device of FIG. 3 are similar to elements in the previous embodiments.

In the third embodiment, the shielding device 3 is provided between the display 1 and the circuit board 7. Hence, noise generated by the circuit board 7 can also be blocked or shielded from the detecting coils 2. As a result, detection by the detection coils 2 provided on the view-surface side of the display 1 can be performed accurately and reliably without substantial interference.

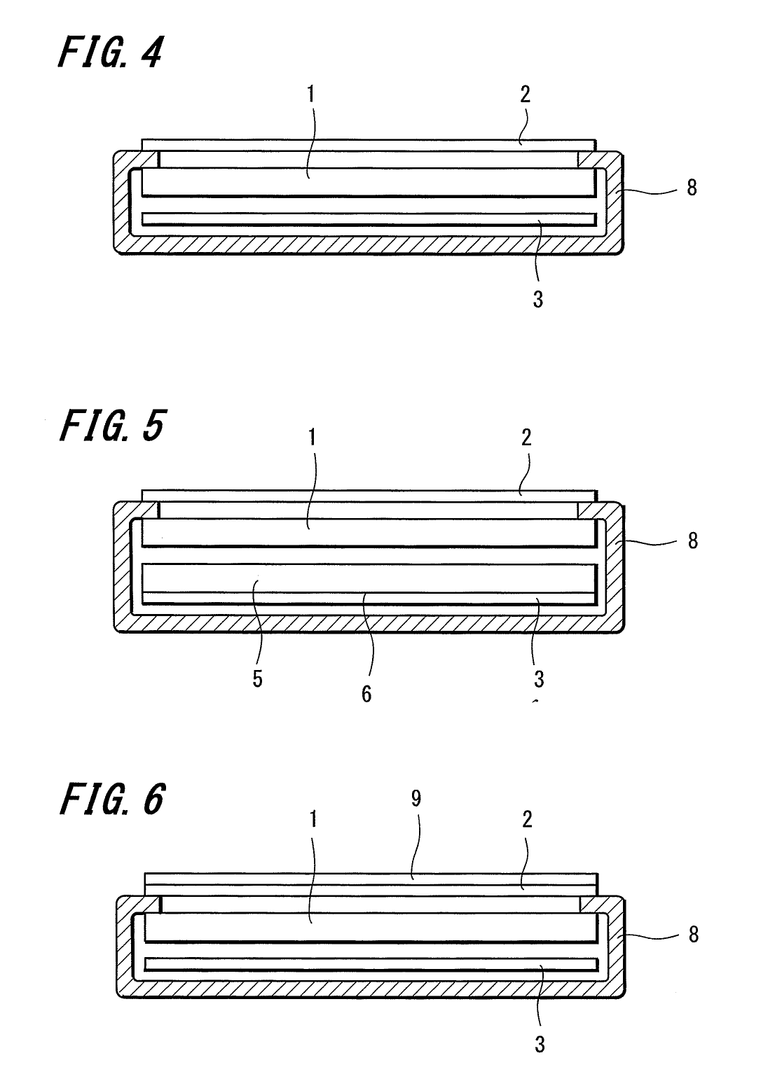

FIG. 4 is a schematic cross-sectional view showing a position detecting device and a display device according to a fourth embodiment of the present invention. In the fourth embodiment, the rear-surface side of the display 1 is surrounded by a metal housing 8. The metal housing 8 results in interference for the detection coils 2 similar to that of the above-described metal desk 4. Other elements of the display/input device of FIG. 4 are similar to elements in the previous embodiments.

As shown in FIG. 4, the rear-surface side of the display 1 is surrounded by the metal housing 8. The detection coils 2 are formed at the view-surface side of the display 1. Further, the shielding device 3 is provided at the rear-surface side of the display 1. Hence, according to the fourth embodiment, the shielding device 3 is positioned between the rear surface side of the display 1 and the metal housing 8 so that eddy currents generated in the metal housing 8 and other undesirable effects can easily be eliminated.

FIG. 5 is a schematic cross-sectional view showing a position detecting device and a display device according to a fifth embodiment of the present invention. In the fifth embodiment, the rear-surface side of the display 1 is surrounded by a metal housing 8, and a backlight module 5 is provided at the rear-surface side of the display 1. Other elements of the display/input device of FIG. 5 are similar to elements in the previous embodiments.

In the embodiment shown in FIG. 5, the shielding device 3 is attached to the rear surface of the backlight module 5 via attachment 6 as best shown in FIG. 5). Here, if there are holes, deformations or the like in the shielding device 3, eddy currents may occur in these portions. Thus, it is preferred that the shielding device 3 be formed having a planar shape with substantially no irregularities. By attaching the shielding device 3 to the rear surface of the backlight module 5 as shown in FIG. 5, a satisfactory shielding effect is obtained.

FIG. 6 is a schematic cross-sectional view showing a position detecting device and a display device according to a sixth embodiment of the present invention. In the sixth embodiment, a pressure-sensing or other-type auxiliary position detector 9 is superposed on the detection coils 2. Other elements of the display/input device of FIG. 6 are similar to elements in the previous embodiments.

Hence, in the sixth embodiment of FIG. 6, eddy currents generated in the metal housing 8 and other undesirable effects can easily be eliminated by providing the shielding device 3 at the rear-surface side of the display 1. Additionally, by providing the pressure-sensing or other-type auxiliary position detector 9, various input methods can be performed with minimal interference.

It should be understood that other embodiments of the present invention may be derived by optionally combining the features of the above-described first through sixth embodiments. It should also be understood that a nonmetal housing can alternatively be used instead of the metal housing 8 in the fourth through sixth embodiments. In this case, the shielding device 3 can be provided on the rear-surface side of the housing. Accordingly, even if a display/input device with such a configuration is placed on a metal desk, interference due to eddy currents therein can be blocked.

According to the embodiments of the present invention, a detector formed of a transparent member is provided on the view-surface side of the display and a shielding device is provided on the rear-surface side of the display to shield the detector from interference. As a result, stable and satisfactory position detection can be performed.

Further, according to the embodiments of the present invention, even if a housing surrounding the rear-surface side of the display portion of a display device is made of metal, a shielding device provided between the rear surface of the display portion and the metal housing blocks or shields interference from the detector. As a result, stable and satisfactory position detection can be performed.

Although embodiments of the present invention have been shown and described, it will be appreciated by those skilled in the art that changes may be made in these embodiments without departing from the principles and spirit of the invention, the scope of which is defined in the appended claims and their equivalents.

I claim:

1. A position detecting device usable with a display having a view-surface side and a rear-surface side opposite the view-surface side, the position detecting device comprising:
a detector formed of a transparent member on the view-surface side of the display; and
a shielding device disposed at the rear-surface side of the display configured to shield the detector from interference.

2. A position detecting device according to claim 1, wherein:
the detector includes an electromagnetic type detection coil; and
the shielding device blocks electromagnetic effects on the detection coil.

3. A position detecting device according to claim 1, further comprising:
a backlight module provided at the rear-surface side of the display,
wherein the shielding device is attached to a rear surface of the backlight module.

4. A position detecting device according to claim 1, further comprising:
driving circuitry provided at the rear-surface side of the display for driving the display to display an image,
wherein the shielding device is provided between the rear-surface side of the display and the driving circuitry.

5. A position detecting device according to claim 1, further comprising:
a metal housing covering the rear-surface side of the display,
wherein the shielding device is provided between the rear-surface side of the display and the metal housing.

6. A position detecting device according to claim 2, further comprising:
an auxiliary position detector in combination with the electromagnetic induction-type detection coil, the auxiliary position detector employing a detection method other than electromagnetic induction.

7. A position detecting device according to claim 1, wherein said shielding device prevents generation of eddy currents in a metal surface located at the rear-side surface of the display.

8. A display device, comprising:
a display panel for displaying images, said display panel having a view-surface side and a rear-surface side opposite the view-surface side;
a detector formed of a transparent member on the view-surface side of the display panel;
a housing surrounding the rear-surface side of the display panel; and
a shielding device disposed between the rear-surface side of the display panel and the housing, said shielding device configured to shield the detector from interference.

9. The display device according to claim 8, wherein the housing is formed of metal.

10. The display device according to claim 8, wherein:
the detector is an electromagnetic induction-type detection coil, and
the shielding device is a shielding plate that blocks electromagnetic effects on the detection coil.

11. The display device according to claim 8, further comprising:
a backlight module operably associated with the display panel,
wherein the shielding device is attached to a rear surface of the backlight module.

12. The display device according to claim 11, further comprising:
an auxiliary position detector in combination with the electromagnetic induction-type detection coil, said auxiliary position detector employing a position detection method other than electromagnetic induction.

13. The display device according to claim 8, wherein the housing comprises:
a bottom portion extending along the rear-surface side of the display panel;
a side portion extending from said bottom portion along sides of said display panel at a non-zero angle with respect to a major plane of said bottom portion, said side portion extending slightly beyond the view-surface side of said display panel; and
a peripheral top portion extending from said side portion over a periphery of the view-surface side of the display panel, said peripheral top portion defining a window through which the images on said display panel are viewable.

14. The display device according claim 13, wherein said transparent detector member is disposed on said peripheral top portion of said housing so as to extend over the window.

15. The display device according to claim 8, further comprising:
a position indicator having a resonance circuit for electromagnetically interacting with said detector, wherein said detector determines a current position of the position indicator based on a comparison of signal strengths of a signal received from the position indicator at a plurality of different detector elements of said detector.

16. The display device according to claim 15, wherein said detector transmits a signal of a predetermined frequency to said position indicator to induce a current in said resonance circuit, and, in response to the induced current, said position indicator transmits a resonant signal based on the induced current back to said detector for determining the current position of said position indicator with respect to the plurality of different detector elements.

17. The display device according to claim 8, wherein said detector comprises an array of detectors extending across the view-surface side of the display panel.

18. The display device according to claim 8, wherein said shield device comprises a planar rectangular metal plate.

19. A position detecting device usable with a display having a view-surface side and a rear-surface side opposite the view-surface side, said position detecting device comprising:
a detecting formed of a transparent member on the view-surface side of the display; and
a shielding device provided at the rear-surface side of the display for shielding the detector from interference.

20. A display device, comprising:
display having a view-surface side and a rear-surface side, said display for displaying an image;
a detector formed of a transparent member on the view-surface side of the display;
a housing formed of metal surrounding the rear-surface side of the display; and
a shield assembly disposed between the rear-surface side of the display and the housing for shielding the detector from interference.

21. A method of shielding a position detector of a display device from interference, the display device including a display panel having opposing front and rear surface sides, a transparent detector disposed at the front surface side, a position indicator for electromagnetic communication with the detector, and a planar metal shielding device disposed at the rear-surface side of the display panel, the method comprising the steps of:
receiving an electromagnetic signal from the position indicator at the detector, the electromagnetic signal having a tendency to generate eddy currents in metal surfaces located at the rear surface side of the display; and
reducing the generation of eddy currents in the metal surfaces and blocking electromagnetic interference from being received at the detector using the planar metal shielding device.
